(19) United States
(12) Patent Application Publication
(10) Pub. No.: US 2018/0054438 A1
(43) Pub. Date: Feb. 22, 2018

(54) PROXY SERVICE FOR UPLOADING DATA FROM A SOURCE TO A DESTINATION

(71) Applicant: MICROSOFT TECHNOLOGY LICENSING, LLC, Redmond, WA (US)

(72) Inventors: Shiliang LI, Beijing (CN); Hai-Yun HE, Beijing (CN); Shanming XUAN, Beijing (CN); Jay D. AUSTIN, Jr., Stockholm (SE)

(73) Assignee: MICROSOFT TECHNOLOGY LICENSING, LLC, Redmond, WA (US)

(21) Appl. No.: 15/553,557

(22) PCT Filed: Mar. 2, 2015
(86) PCT No.: PCT/CN2015/073485

§ 371 Date: Aug. 24, 2017

(51) Int. Cl. H04L 29/06

(52) U.S. Cl. CPC H04L 63/0876; H04L 63/0281; H04L 67/28; H04L 63/0236; H04L 63/126

(57) ABSTRACT

Automatically ensuring that data uploads to a secure destination storage repository and data read/download requests are processed from trustworthy sources/requesters is provided. When data uploads are attempted to secure destination storage repositories from sources not previously identified as trustworthy, or when data requests are received for downloading or reading data from such secure storage repositories are received from such sources, the uploads or data requests as passed through a proxy service for authentication. Authentication steps are performed by the proxy service to ensure that data coming from a data uploader directed to a secure storage repository is associated with a source that may be designated as trustworthy. Similarly, requests to read or download data from a secure storage repository are authenticated to ensure that the requester is associated with a device or system that may be designated as trustworthy.

### BACKGROUND

In modern computing systems, large amounts of data are generated and stored on one or more computers in association with databases, electronic mail systems, web services systems, online software provision systems, document management systems, and the like. In some cases, large data centers house hundreds or even thousands of computers on which are run various software applications and on which are stored data of many types for one or more computing system users. For example, a large data center may be used for processing and storing data of various types for hundreds, thousands or more individual users, companies, educational entities, or any other entity for which data may be processed and stored.

There is often a need to upload data of various types from one or many of such computers to various destination storage repositories at which the data may be stored, analyzed, or otherwise utilized by recipients. In some cases, such data is uploaded to a large data center where the data is partitioned and stored according to data type. In order to secure such data storage locations/repositories, uploads of data and/or data downloads from unauthorized sources/requesters may be rejected even though such uploads or downloads may be needed for one or more authorized users. There is a need for methods and systems for authenticating data uploads and data downloads/read requests from sources/requesters not previously designated as trustworthy sources/requesters. It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

The above and other problems are solved by automatically ensuring that data uploads to a secure destination storage repository and data read/download requests are processed from trustworthy sources/requesters. When data uploads are attempted to secure destination storage repositories from sources not previously identified as trustworthy, or when data requests are received for downloading or reading data from such secure storage repositories are received from such sources, the uploads or data requests as passed through a proxy service for authentication. According to aspects of the invention, various authentication steps are performed by the proxy service to ensure that data coming from a data uploader directed to a secure storage repository is associated with a source that may be designated as trustworthy. Similarly, requests to read or download data from a secure storage repository are authenticated to ensure that the requester is associated with a device or system that may be designated as trustworthy.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various aspects of the present invention.

FIG. 1 is a simplified block diagram of one example of a system architecture for ensuring that data uploads to a secure destination storage repository and data read/download requests are processed from trustworthy sources/requesters.

FIG. 2A is a simplified block diagram of one example of a data uploader module for uploading data from a source location to a destination location.

FIG. 2B is a simplified block diagram of one example of a proxy service for ensuring that data uploads to a secure destination storage repository and data read/download requests are processed from trustworthy sources/requesters.

FIG. 3 is a flowchart of an example method for ensuring that data uploads to a secure destination storage repository and data read/download requests are processed from trustworthy sources/requesters.

FIG. 4 is a block diagram illustrating example physical components of a computing device with which aspects of the present invention may be practiced.

FIGS. 5A and 5B are simplified block diagrams of a mobile computing device with which aspects of the present invention may be practiced.

FIG. 6 is a simplified block diagram of a distributed computing system in which aspects of the present invention may be practiced.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

As briefly described above, aspects of the present invention are directed to automatically ensuring that data uploads to a secure destination storage repository and data read/download requests are processed from trustworthy sources/requesters. According to aspects of the invention, when data uploads are attempted to secure destination storage repositories from sources not previously identified as trustworthy, or when data requests are received for downloading or reading data from such secure storage repositories are received from such sources, the uploads or data requests as passed through a proxy service for authentication. According to aspects of the invention, the proxy service compares an IP address associated with the data source/requester against a list of IP addresses known to be associated with trustworthy sources/requesters. If an IP address associated with the data source/requester does not match IP addresses known to be associated with trustworthy sources/requesters, the attempted data upload or data request may be rejected, and additional authentication information may be requested from the data source/requester. As an additional authentication step, the proxy service may compare an authentication certificate associated with a data uploader module through which a data upload is attempted or through which a data request is attempted with a list of certificates know to be associated with trustworthy sources. If the certificate of the data uploader module matches a trustworthy certificate, then the data upload or data read/download request is processed as requested. If the secure data storage repository attempts to pass a return signal back to the data uploader module in response to a data upload attempt or data download/read request, the return traffic from the secure storage repository similarly is passed through the proxy service for authentication before it may be forwarded to the data upload/data download/read requester.

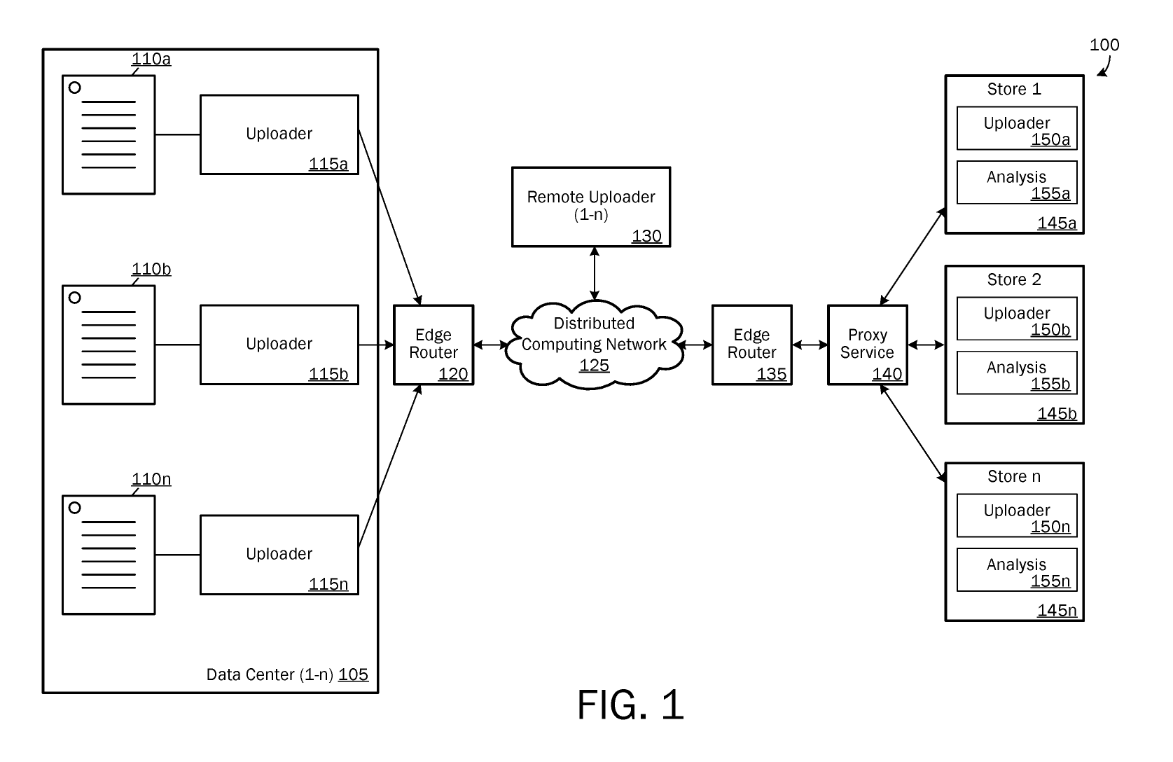

FIG. 1 is a simplified block diagram of one example of a system architecture for monitoring and reporting of the uploading and uploading completeness of data from a source location to a destination location. The system architecture 100 is comprised of various example computing components for uploading data from a variety of source computing systems (or individual computers) to a variety of destination storage repositories. On the left side of FIG. 1, a data center 105 is illustrative of a data center in which may be housed hundreds, thousands or more individual computers or computing systems 110a, 110b, 110n on which may be stored data of a variety of data types that may be processed using a variety of different computing processes, for example, a variety of software applications. For example, each of the computing devices 110a, 110b, 110n may include computers of various types, for example, server computers, for storing user data in databases, electronic mail systems, document management systems, and the like, and the computing systems 110a, 110b and 110n may be used for running a variety of computing system software applications, for example, database applications, electronic mail systems applications, web services applications, online software provision applications, productivity applications, data management system applications, telecommunications applications, and the like.

As should be appreciated, the data center 105 is also illustrative of one of many data centers that may be co-located, or that may be located at different locations and that may be associated with each other via various transmission systems for passing data between disparate data centers. In addition, while the data center 105 is illustrated as a data center in which numerous computer systems 110a-n may be located for provision of data and services, as described above, the data center 105 is equally illustrative of a single computing device, for example, a desktop, laptop, tablet, handheld, or other computing device operated by an individual user from which user data and/or computer system data may be extracted, transformed (if required) and exported to a destination storage repository for analysis and further use, as desired.

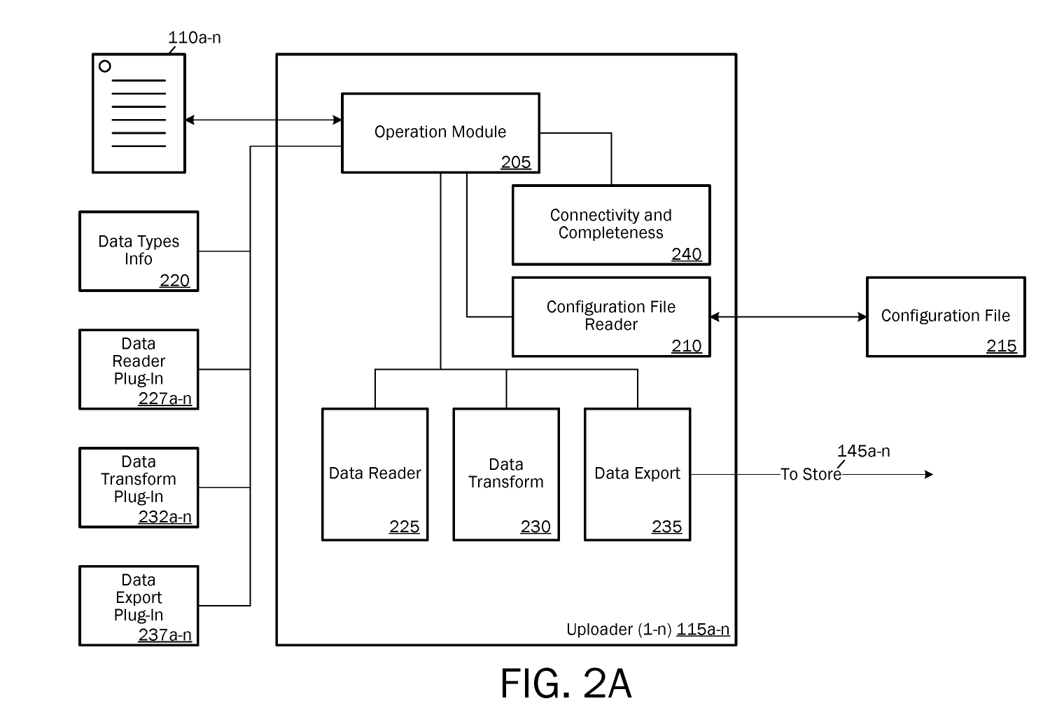

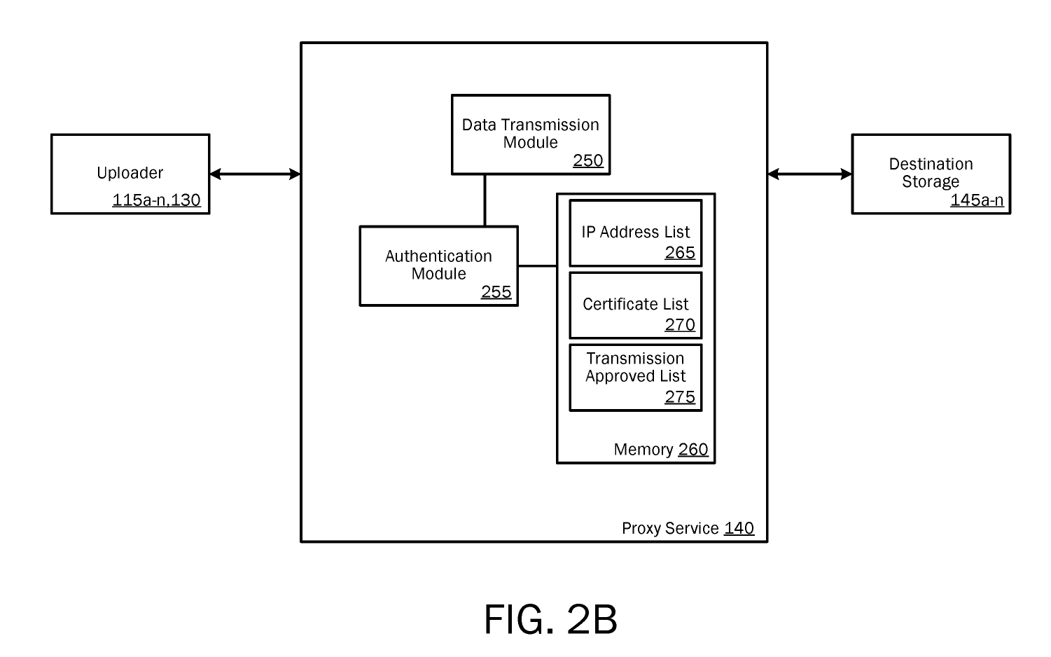

Referring still to the data center 105, each computing device 110a-n is associated with an uploader module 115a, 115b, 115n, respectively, that is operative for uploading user and/or system data from each associated computer/computing system 110a-n and for transforming, if required, and exporting the extracted data to a designated destination storage repository. The uploader module 115a-n is described in further detail below with respect to FIG. 2. According to one aspect of the invention, an uploader module 115a-n may be installed on each associated computer/computing system 110a-n.

Alternatively, a single uploader module 115a may be operated as a standalone module that may be associated with a plurality of computing systems 110a-n. In such a case, the uploader module may operate as a remote uploader module 130 that may access one or more associated computing systems 110a-n through a distributed computing network, for example, the Internet or an intranet. That is, according to aspects of the invention, the uploader module 115a-n may be installed on an associated computing device 110a-n, or the uploader module may operate remotely of a computing device from which data may be extracted for transformation of the data, if required, and for exporting the data to a destination storage repository, as described herein.

Referring still to FIG. 1, an edge router 120 is illustrative of a typical router device for passing extracted data from a given uploader module to systems external to the data center 105. As should be appreciated, the edge router 120 may be responsible for ensuring that data passed from a given data center 105 is properly passed to a desired destination system component, for example, that packetized data passing from the uploader module is properly routed to a correct destination component of the system 100.

The distributed computing network 125 is illustrative of any network such as the Internet or an intranet through which data may be passed from the data center to components external to the data center such as destination storage repositories 145a-n, described below.

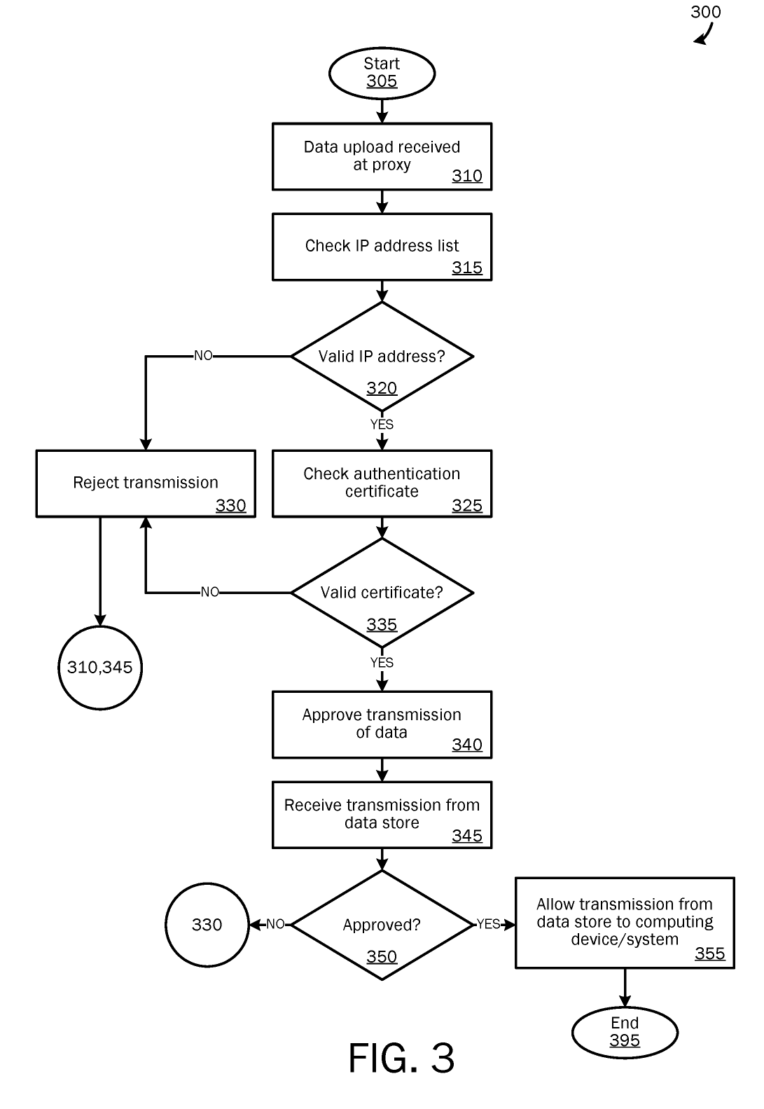

The edge router 135 is illustrative or a receiving edge router through which data may be passed to a proxy service 140 responsible for ensuring received data is properly authenticated prior to allowing received data to be passed to one or more destination storage repositories 145a-n. The proxy service 140 is described in further detail below with reference to FIGS. 2B and 3.

The storage repositories 145a-n are illustrative of any data storage repository that may be authorized to receive data uploaded via the uploader modules 115a-n. For example, the destination storage repositories 145a-n may be associated with a services provider for storing and analyzing data associated with computing systems and software services provided for customers of the services provider. For example, the storage repository 145a may be designated for receiving user data and computing system data associated with electronic mail services provided by a given services provider. The storage repository 145b may be designated for receiving and analyzing user data and systems data associated with web services of a given services provider. Similarly, the destination storage repository 145n may be associated with online software provision, for example, provision of word processing services, slide presentation application services, database application services, spreadsheet application services, telecommunications application services, and the like provided to various users via one or more online software application services systems.

As should be appreciated, each of the destination storage repositories 145a-n may be associated with different services providers or with different requesters of user and/or computing system data. For example, the repository 145a may be associated with a first telecommunications or software application services provider, the repository 145b may be associated with a second services provider, and so on.

As will be understood by those skilled in the art, providers of computing system services, data management services, online software application services, web services, and the like often need to examine, analyze and otherwise manage computing systems data and user data to ensure that data and computing systems services are operating and being maintained as required. For example, a provider of online software services may need to periodically audit the operating functionalities and capabilities of hundreds or thousands of server computers 110a-n maintained at a large data center 105. Likewise, a provider of online software services may need to monitor user data stored on such data center systems to ensure that user data is being properly processed as required by services agreements between the services provider and various customers. In such a case, operating data and/or used data from a given computer may be extracted by an associated uploader module 115a according to any data type associated with the extracted data and may be passed to and stored at a desired storage repository 145a-n for analysis by a requesting services provider or user.

Before the data is passed to the destination storage repository, the data may require transformation for a variety of reasons. For example, if the data contains sensitive confidential and/or personal information associated with a given user, for example, the user's name, social security number, driver's license number, financial data, and the like, such personally identifiable information (PII) may be scrubbed from the data by the uploader module before the data is passed to the destination storage repository to prevent such personally identifiable information from being passed to an unauthorized person or entity. Similarly, if the data extracted from a given computer of computing system at the data center 105 is stored according to a first format, but the data will be stored at the desired destination storage repository according to a second format, the uploader module 115 may transform the data from the first format to the second format so that it may be properly stored and utilized at the destination storage repository.

Referring still to FIG. 1, according to aspects of the present invention, each destination storage repository 145a-n may be equipped with or associated with uploader modules 150a, 150b, 150n that may be used for extracting, transforming, and storing user data and/or computing system data from computing systems 110a, 110b, 110n at the data center 105 remotely from the data center 105. That is, the uploader modules 150a through 150n may be operated from each requesting destination storage repository 145a, 145b, 145n for requesting, reading, transforming, and storing required user or computing system data. Thus, as described above, the uploader modules 115a, 115b, 115n may be installed on or associated with individual computing systems 110a through 110n, a remote uploader 130 may be used for reading, transforming, and exporting data via a distributing computing network that may be used for accessing desired computing systems 110a through 110n, or the uploader modules 150a, 150b, 150n may access required data remotely from individual destination storage repositories. Alternatively, the uploader modules 150a-n may be used from extracting, transforming and exporting data from the storage repositories 145a-n in the same manner as described for exporting data from the computing systems 110a-n.

The analysis modules 155a, 155b, 155n are illustrative of software applications or other executable modules at the storage repositories 145a-n that may be utilized for analyzing, reporting, and exporting received data, as desired. For example, an analysis module 155a may be operative to analyze documents generated by provided online software services to ensure that such documents were properly saved at respective computing devices 110a-n, as required. An analysis module 155b may be illustrative of a software application or other executable module for analyzing electronic mail traffic for ensuring that electronic mail messages were generated and processed at an associated data center computing device 110a-n according to required electronic mail services processing. That is, any analysis module 155a-n may be utilized at a given destination storage repository for analyzing received data as required by the recipient of the data from the uploader modules 115a-n, 130, 150a-150n.

According to aspects of the invention, data that is stored at analyzed and otherwise utilized at any of the destination storage repositories 145a-145n may be subsequently exported to other destinations, as desired. For example, such data may be analyzed and reported to customers of one or more services providers for reporting periodically on processing performed by the services provider for the requesting customers. In addition, data stored at any of the destination storage repositories 145a-n may be passed back through the system 100 illustrated in FIG. 1 for storage back at the computing devices 110a-n from which the data was originally extracted.

Referring now to FIG. 2A, the data uploader 115a-n is illustrated and described. As briefly described above, the uploader 115a-n is a software application or software module containing sufficient computer executable instructions for reading, transforming (if required) and exporting data of a variety of data types from one or many data sources 110a-n to one or many data storage 145a-n. The data uploader 115a-n includes an operation module 205 for receiving data upload instructions and for directing the processing of components of the data uploader module 115a-n. A configuration file reader 210 is a module with which the data uploader 115a-n reads a configuration file 215 for data uploading instructions, as described below. A data reader module 225 is operative to read data of a variety of data types via a data reader plug-in module 227a-n. A data transformation module 230 is a module operative for transforming data in response to data transformation information read from the configuration file 215 via a data transformation plug-in 232a-n. A data export module 235 is operative to export data from memory to a designated destination storage repository 145a-n as designated by instructions received from the configuration file 215 via the data export plug-in 237a-n.

That is, the data reader module 225, data transformation module 230, data export module 235 are modules of the data uploader module 115a-n operative to read, transform and export data of a variety of types as designated by information contained in the configuration file 215. And, each of the modules 225, 230, 235 may be enabled to read, transform and export data as instructed based on a variety of plug-ins 227, 232, 237 accessed by the data uploader operation module 205 or installed on the data uploader 115a-n to allow the uploader 115a-n to read, transform and export data according to a variety of data types 220 that are designated for uploading to a given destination storage repository 145a-n.

Various data reader, data transformation and data export plug-in modules 227, 232, 237 may be provided to the data uploaders 115a-n or may be accessed by the data loader modules 115a-n as required for different types of data reading transformation and export. For example, a services provider which needs to receive transformed data from various computing devices operated at a data center 105 may provide data reader plug-ins, data transformation plug-ins, and data export plug-ins for use by data uploader modules 115a-n for reading, transforming and exporting data according to their individual needs.

Data that may be read, transformed, and exported, as described herein, may be of an almost limitless number of different data types. Such data may be in the form of operating systems events, text files, XML files, HTML files, contents of data bases (e.g., SQL databases), electronic mail files, calendaring information, word processing documents, spreadsheet documents, slide presentation documents, tasks documents and files, and the like.

As should be appreciated, a given data uploader 115a-n may be installed on a given computing device 110a-n or may be otherwise associated with or provided access to a given computing device 110a-n, and the data uploader 115a-n may be enabled for reading data of many different types by associating a data reader plug-in 227a-n to allow the uploader 115a-n to read data of a designated type. Similarly, the uploader 115a-n may be enabled to transform data as desired by associating the uploader with a data transformation plug-in required for the desired transformation. Similarly, the uploader module 115a-n may be enabled to export data as desired by associating the uploader with an appropriate data export plug-in 237a-n.

The configuration file 215a is illustrative of a file that may be accessed by the uploader module 115a-n for receiving data uploading instructions for a given set or type of data. Data uploading instructions contained in the configuration file may provide information including the data types associated with data to be uploaded, data reading instructions, as well as, security information for allowing the uploader module to access desired data. In addition, the configuration file may provide instructions on how desired data is to be transformed, if required, and instructions on where uploaded data is to be stored and in what file type exported data is to be stored.

Referring still to FIG. 2A, a connectivity and completeness module 240 is illustrative of a software module operated in or associated with the uploader module 115a-n containing sufficient computer executable instructions for monitoring and reporting upload success and completeness of data uploaded from a source computing system 110a-n to a destination storage repository 145a-n, as described above. According to aspects of the invention, the connectivity and completeness module 240 is operated by the uploader module 115a-n at the direction of the operation module 205 to perform connectivity diagnostics for testing the reliability of data transmission between a given source system 110a-n and a designated destination storage repository 145a-n.

Referring now to FIG. 2B, the proxy service 140 is a system or software module operative to authenticate requests for uploading data to a secure destination storage repository 145a-n and/or for authenticating data download/read requests from a secure destination storage repository 145a-n. Consider for example that data, whether user data or system data, is to be uploaded from a computing device/system 110a-n via an uploader module 115a-n to a secure storage repository 145a-n, or where a request to download data or read data stored at a secure destination storage repository is received from a computing device/system 110a-n. Consider further for example that the computing device/system 110a-n from which the data upload is requested or from which the data download/read request is received is a computing device/system that operates external to the storage repository to which the request is passed. For example, the storage repository may be part of an internal corporate entity data storage system and the computing device from which the upload/download/read request is received may be operated by a third party entity operating outside a secure network or data center in which the storage repository is maintained. In such a case, it may be possible for harmful or other undesired data to be uploaded to the secure storage repository, or it may be possible for sensitive data and other information to be downloaded or read from the secure storage repository by unauthorized persons or entities.

According to aspects of the present invention, the proxy service 140 is a system component and/or software module operative for authenticating data upload or data download/read requests made to secure destination storage locations/repositories to prevent unauthorized uploading or access to secure data. Referring still to FIG. 2B, the proxy service 140 includes a data transmission module 250 which is a software module and/or system component operative to receive data transmissions from an uploader module 115a-n, 130 for passing uploaded data from a computing device 110a-n onto which the uploader module 115a-n, 130 is installed or with which the uploader is associated to a destination storage repository 145a-n. The data transmission module 250 is also operative to pass downloaded data or data responsive to read requests from the destination storage repository to a requesting computing device 110a-n via the uploader 115a-n, 130. The authentication module 255 is a device or software module operative to authenticate the source of a data upload/download/read request to ensure that the source is trustworthy for either uploading data to a secure repository or for downloading or reading data from a secure repository.

The memory 260 is illustrative of a memory location housed either in the proxy service 140 or accessible by the proxy service 140 in which may be stored information required for authenticating upload/download/read requests. According to aspects of the invention, the Internet protocol (IP) address list 265 is illustrative of a list of IP addresses that may be used for comparing against an IP address associated with a data upload/download/read requester. The certificate list 270 is illustrative of a list of authentication certificates that may be used to compare with an authentication certificate associated with a data upload/download/read requester. A transmission approved list 275 is illustrative of a list of approved sources from which upload/download/read requests previously have been authenticated and approved.

Having described an example architecture for various aspects of the present invention, FIG. 3 is a flowchart of an example method for ensuring that data uploads to a secure destination storage repository and data read/download requests are processed from trustworthy sources/requesters. The method 300 begins at start operation 305 and proceeds to operation 310 where a data upload request is received at the proxy service 140. As illustrated and described above with reference with FIGS. 1 and 2, consider for example that a request to upload data from a computing device/system 110a-n is passed through an installed or associated data uploader 115a-n for storage at a designated destination storage repository 145a-n. At operation 310, the data upload is passed from the sending data uploader 115a-n to the proxy service 140 for authentication of the data upload source.

According to aspects of the invention, every data upload passed to a designated storage location repository 145a-n from any data uploader 115a-n may be passed through the proxy service 140 for authentication. On the other hand, if the data upload is coming from a computing device/system 110a-n that is a component of a network of systems in which the designated storage repository is located or if the sending device is part of the same corporate or other operating entity in which the designated destination storage repository is operated, then authentication of the source of the data upload may be bypassed.

According to one aspect of the invention, a determination of whether a data upload request is passed through the proxy service 140 may be based on the data export plug-in 237a-n utilized by the data upload 115a-n for exporting the uploaded data to the designated destination storage repository. That is, when the data uploader 115a-n reads the configuration file 215, as described above with reference to FIG. 2A, if the data uploader is installed on or is associated with a computing device/system 110a-n from which data uploads/downloads/read requests do not require authentication, then the configuration file 215 may be used to direct the data uploader 115a-n to utilize a data export plug-in that may send the data upload/download/read request directly to the designated destination storage location repository without passing the request through the proxy service 140. Likewise, data uploaders installed on computing devices/systems 110a-n that may not bypass the proxy service 140 (that is, requiring authentication) may be provided with an export plug-in 237a-n that automatically causes data uploads/downloads/read requests transmitted from the data uploader to travel first to the proxy service 140. As should be appreciated, the data uploader 115 will be unaware that the request is being passed to the proxy service as opposed to the data storage repository. That is, the uploader module will simply pass the request through the data export plug-in 237a-n to which it is directed by the configuration file 215, and the outgoing request will go either to the proxy service 140 or to the designated data storage repository as required.

At operation 315, when a data upload/download/read request is received at the proxy service 140, an IP address for the computing device/system 110a-n from which the request is received is compared against a list of IP addresses 265 maintained by or accessed by the proxy service 140 for determining whether the IP address associated with the requesting device matches an IP address that previously has been authenticated successfully by the proxy service 140 from which valid upload/download/read requests may be received. At operation 320, if it is determined that the IP address associated with the requesting device does not match an IP address associated with a previously authenticated device, the method 300 may proceed to operation 330 where the transmission may be rejected meaning that the transmission and data upload/download/read request will not be passed to the designated storage location repository. According to one aspect, if the transmission is rejected at operation 330, signaling may be passed back to the sending data uploader requesting additional authentication information from the sending device. As should be appreciated, additional authentication information may include a variety of information types, including but not limited to, usernames, passwords, authentication certificates, encrypted keys, identification codes/numbers for the requesting device, and the like.

Referring back to operation 320, if it is determined that the IP address associated with the sending device does match an IP address previously authenticated by the proxy service 140, the method 300 may proceed to operation 325. At operation 325, an authentication certificate associated with the requesting device 110a-n may be compared against a list of authorized certificates 270 by the proxy service 140 for determining whether the requesting device 110a-n previously has been authenticated via certificate as a valid data upload/download/read requesting source. At operation 335 if it is determined that the certificate received from the requesting device does not match a previously authenticated requesting device certificate, then the method may proceed to operation 330 where the transmission may be rejected, and the method may proceed back to operation 310 where a request for additional authentication information may be requested from the proxy service 140, as described above. At operation 335, if the certificate comparison results in a valid certificate, then the method may proceed to operation 340 where transmission of the data upload may be approved.

As should be appreciated, the IP address comparison at operation 320 and the certificate comparison at operation 335 may operate as a two-step authentication process, as illustrated and described with reference to FIG. 3. Alternatively, either the IP address validation or the certificate validation may operate as independent authentication steps wherein, if either step is passed (that is, valid IP address or valid certificate), then the requesting device may be passed as an authenticated device for uploading/downloading or reading data to/from the designated destination storage repository. That is, as should be appreciated, in some cases, it may be determined that only one of the two authentication steps may be required to provide acceptable security reliability for allowing data to be uploaded, downloaded or read from a given storage repository. In some cases, security levels associated with a storage repository and data maintained therein may require only a one step authentication process while other security levels may require both steps as required by owners/maintainers of the data.

As should be appreciated, other types of authentication processing may similarly be used by the proxy service 140. For example, an encrypted key received from the requesting device via its installed or associated data uploader may be compared against a list of approved encrypted keys maintained by the proxy service 140. Thus, a number of different identification/authentication codes/keys/alpha numeric designators, and the like may be used for comparing a requesting source to a list of previously authenticated requesting sources for providing access to a designated storage repository.

As should be appreciated, after the transmission of a data upload is allowed, the receiving storage location repository may pass a return signal back to the source device/system 110a-n for verifying storage of the uploaded data. In such a case, the return signaling from the receiving storage repository may pass back through the proxy service 140 to the source device, or the source device may be designated for allowing the return signal to automatically bypass the proxy service 140 owing to the previous authentication performed for the source device. In addition, if the original request from the source device was in the form of a download/read request from the source device, a responsive download or read access from the storage repository may be passed back through the proxy service 140 for authentication of the source device, as described above.

Referring still to FIG. 3, in some cases, a data download may be attempted from a secure data storage repository 145a-n in the form of a data download or read access to data stored at a given data storage repository directed to a possibly unsecure device/system 110a-n. That is, a data download or read access to stored data may originate from a secure data storage repository directed to a potentially unsecure device/system 110a-n as a reverse cycle to the cycle described above with reference to operations 310 through 340. At operation 345, the cycle described above with reference to operations 310 through 340 may be processed wherein the data download/read request passed from the storage location repository 145a-n is passed through respective uploaders 150a-n through the proxy service 140 for determining whether the intended recipient of the data from a secure repository 145a-n may be authenticated for receiving data from the storage repository 145a-n. At operation 350, if the destination device/system is not approved by the proxy service 140, then the method 300 may proceed to operation 330 and the transmission may be rejected, as described above. If at operation 350 the requested transmission is approved, then at operation 355 the transmission of data from the secure storage repository may be allowed to the destination computing device/system via the proxy service 140. The method 300 ends at operation 395.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

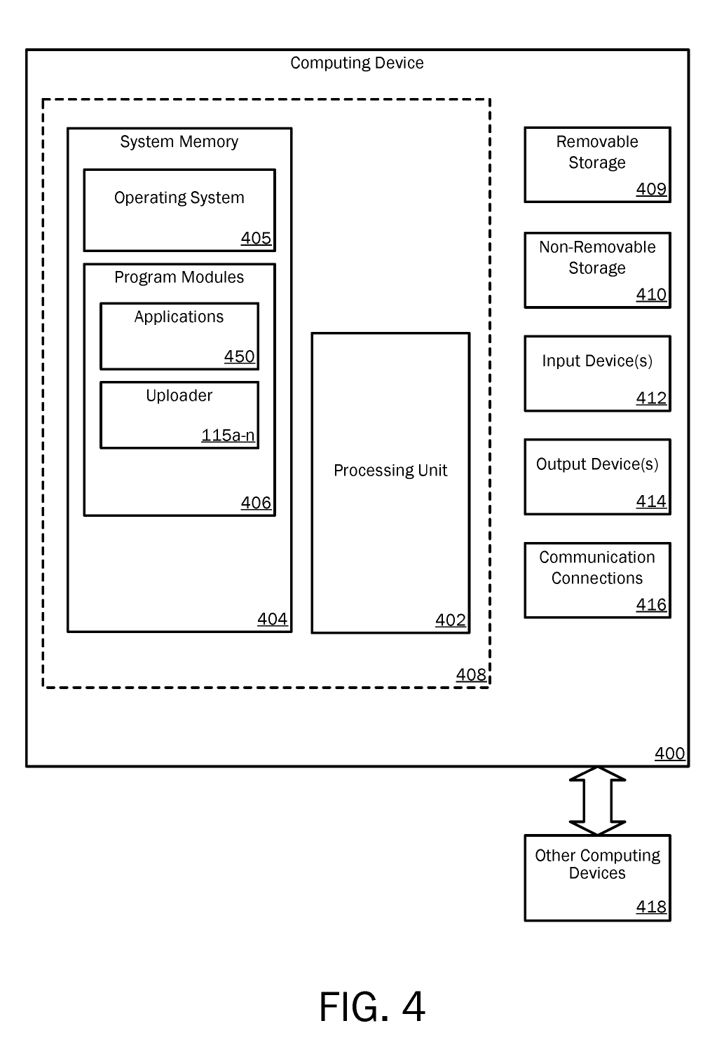

FIGS. 4-6 and the associated descriptions provide a discussion of a variety of operating environments in which embodiments of the invention may be practiced. However, the devices and systems illustrated and discussed with respect to FIGS. 4-6 are for purposes of example and illustration and are not limiting of a vast number of computing device configurations that may be utilized for practicing embodiments of the invention, described herein.

FIG. 4 is a block diagram illustrating physical components (i.e., hardware) of a computing device 400 with which embodiments of the invention may be practiced. The computing device components described below may be suitable for the computing devices 110, 115, 145, described above. In a basic configuration, the computing device 400 may include at least one processing unit 402 and a system memory 404. Depending on the configuration and type of computing device, the system memory 404 may comprise, but is not limited to, volatile storage (e.g., random access memory), non-volatile storage (e.g., read-only memory), flash memory, or any combination of such memories. The system memory 404 may include an operating system 405 and one or more program modules 406 suitable for running software applications 450. The operating system 405, for example, may be suitable for controlling the operation of the computing device 400. Furthermore, embodiments of the invention may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 404. While executing on the processing unit 402, the program modules 406 may perform processes including, but not limited to, one or more of the stages of the method 300 illustrated in FIG. 3. Other program modules that may be used in accordance with embodiments of the present invention and may include applications such as electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing an activity stream across multiple workloads may be operated via application-specific logic integrated with other components of the computing device 400 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 400 may also have one or more input device(s) 412 such as a keyboard, a mouse, a pen, a sound input device, a touch input device, etc. The output device(s) 414 such as a display, speakers, a printer, etc. may also be included. The aforementioned devices are examples and others may be used. The computing device 400 may include one or more communication connections 416 allowing communications with other computing devices 418. Examples of suitable communication connections 416 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

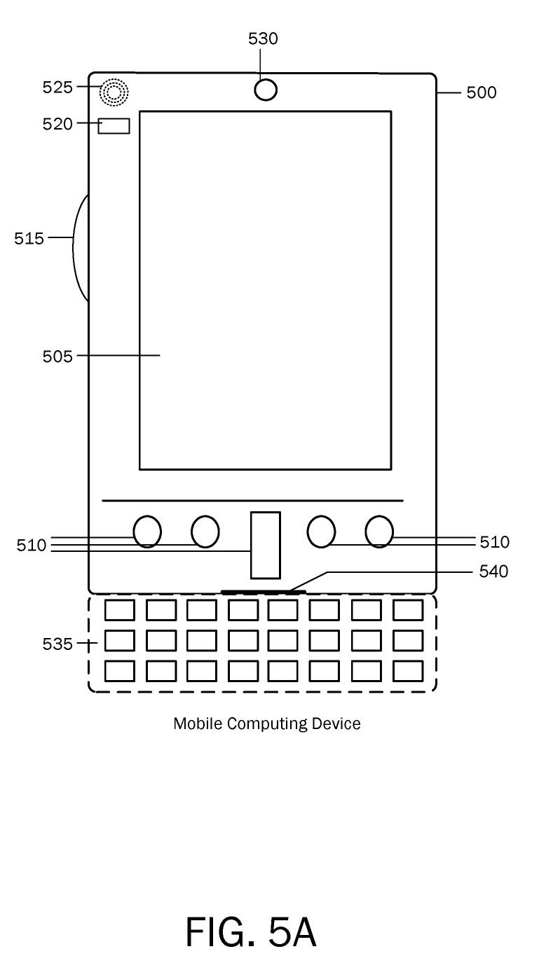

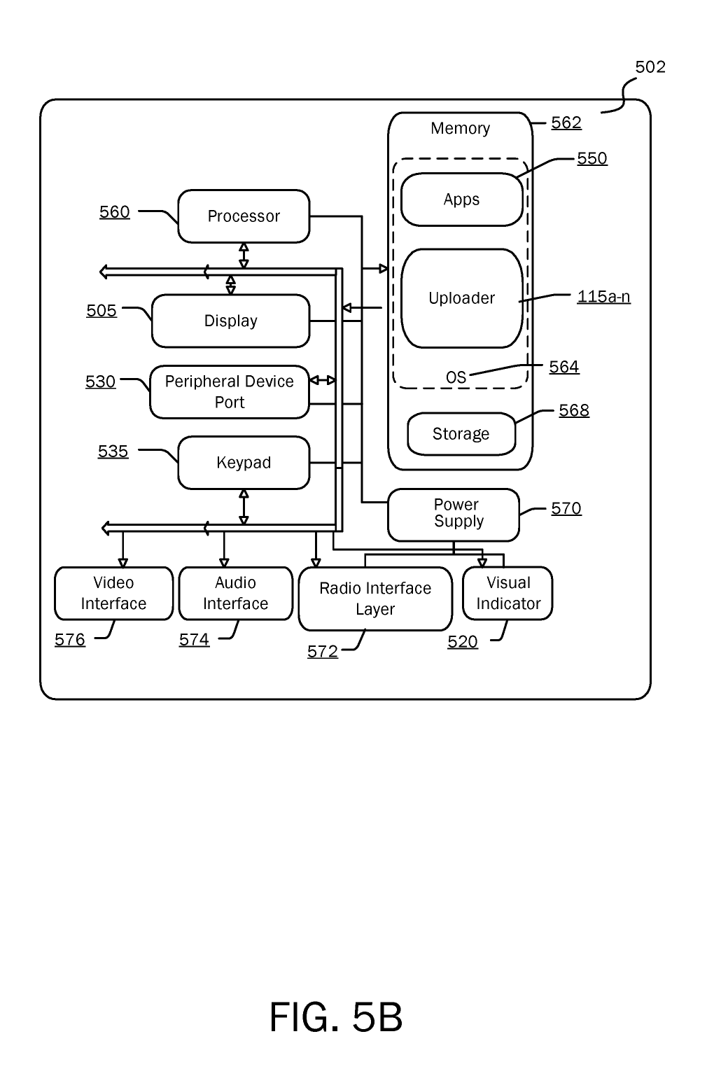

FIGS. 5A and 5B illustrate a mobile computing device 500, for example, a mobile telephone, a smart phone, a tablet personal computer, a laptop computer, and the like, with which embodiments of the invention may be practiced. With reference to FIG. 5A, one embodiment of a mobile computing device 500 for implementing the embodiments is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display). If included, an optional side input element 515 allows further user input. The side input element 515 may be a rotary switch, a button, or any other type of manual input element. In alternative embodiments, mobile computing device 500 may incorporate more or less input elements. For example, the display 505 may not be a touch screen in some embodiments. In yet another alternative embodiment, the mobile computing device 500 is a portable phone system, such as a cellular phone. The mobile computing device 500 may also include an optional keypad 535. Optional keypad 535 may be a physical keypad or a “soft” keypad generated on the touch screen display. In various embodiments, the output elements include the display 505 for showing a graphical user interface (GUI), a visual indicator 520 (e.g., a light emitting diode), and/or an audio transducer 525 (e.g., a speaker). In some embodiments, the mobile computing device 500 incorporates a vibration transducer for providing the user with tactile feedback. In yet another embodiment, the mobile computing device 500 incorporates peripheral device port 540, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one embodiment of a mobile computing device. That is, the mobile computing device 500 can incorporate a system (i.e., an architecture) 502 to implement some embodiments. In one embodiment, the system 502 is implemented as a “smart phone” capable of running one or more applications (e.g., browser, e-mail, calendaring, contact managers, messaging clients, games, and media clients/players). In some embodiments, the system 502 is integrated as a computing device, such as an integrated personal digital assistant (PDA) and wireless phone.

One or more application programs 550 may be loaded into the memory 562 and run on or in association with the operating system 564. Examples of the application programs include phone dialer programs, electronic communication applications, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 550 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500.

The system 502 has a power supply 570, which may be implemented as one or more batteries. The power supply 570 might further include an external power source, such as an AC adapter or a powered docking cradle that supplements or recharges the batteries.

The system 502 may also include a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of the operating system 564. In other words, communications received by the radio 572 may be disseminated to the application programs 550 via the operating system 564, and vice versa.

The visual indicator 520 may be used to provide visual notifications and/or an audio interface 574 may be used for producing audible notifications via the audio transducer 525. In the illustrated embodiment, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present invention, the microphone may also serve as an audio sensor to facilitate control of notifications, as will be described below. The system 502 may further include a video interface 576 that enables an operation of an on-board camera 530 to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio 572 or via a distributed computing network. Similarly, such data/information may be readily transferred between computing devices for storage and use according to well-known data/information transfer and storage means, including electronic mail and collaborative data/information sharing systems.

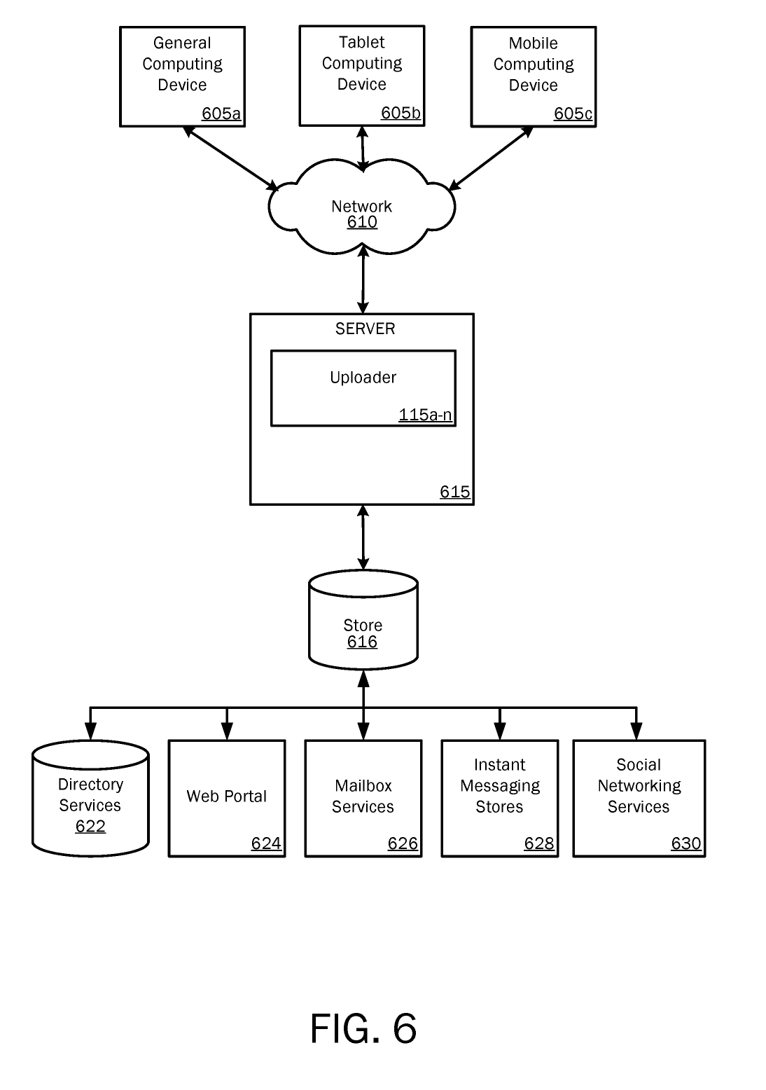

FIG. 6 illustrates one embodiment of the architecture of a system for providing the functionality described herein across components of a distributed computing environment. Content developed, interacted with, or edited in association with the applications described above may be stored in different communication channels or other storage types. For example, various documents may be stored using a directory service 622, a web portal 624, a mailbox service 626, an instant messaging store 628, or a social networking site 630. The application 450 (e.g., an electronic communication application) may use any of these types of systems or the like for providing the functionalities described herein across multiple workloads, as described herein. A server 615 may provide the functionality to clients 605A-C and 110a-n. As one example, the server 615 may be a web server providing the application functionality described herein over the web. The server 615 may provide the application functionality over the web to clients 605A-C and 110a-n through a network 125, 610. By way of example, a computing devices 110a-n may be implemented and embodied in a personal computer 605A, a tablet computing device 605B and/or a mobile computing device 605C (e.g., a smart phone), or other computing device. Any of these embodiments of the client computing device may obtain content from the store 616.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A computer implemented method for uploading data from a source computing system to a secure destination computing system, comprising:
receiving a request to upload data from a source computing system to a destination computing system;
uploading the requested data to a proxy service for authenticating the source computing system as a trustworthy source;
at the proxy service, determining whether the source computing system from which the data is uploaded is a trustworthy source by comparing authentication information provided with the uploaded requested data with authentication information associated with previously designated secure source computing systems; and
if the source computing system is determined to be a trustworthy source, uploading the requested data to the destination computing system.

2. The computer implemented method of claim 1, after receiving a request to upload data from the source computing system to the destination computing system, determining whether the data upload from the source computing system must be authenticated before it may be uploaded to the destination computing system.

3. The computer implemented method of claim 2, wherein determining whether the data upload from the source computing system must be authenticated includes reading a configuration file for determining an export plug-in module required for uploading data from the source computing system to the destination computing system.

4. The computer implemented method of claim 3, wherein determining whether the data upload from the source computing system must be authenticated includes determining whether the export plug-in module required for uploading data from the source computing system causes an uploading of data from the source computing system to the proxy service for authentication of the source computing system as a trustworthy source.

5. The computer implemented method of claim 1, wherein uploading the requested data to a proxy service includes uploading the requested data to the proxy service because the uploaded data is uploaded from the source computing system via an export plug-in module associated with the proxy service.

6. The computer implemented method of claim 1, wherein determining whether the source computing system from which the data is uploaded is a trustworthy source includes comparing an Internet protocol (IP) address associated with the source computing system with one or more IP addresses previously designated as associated with trustworthy sources.

7. The computer implemented method of claim 6, wherein if an IP address associated with the source computing system matches an IP address previously designated as associated with a trustworthy source, allowing an upload of the requested data from the source computing system to the destination computing system.

8. The computer implemented method of claim 6, wherein if an IP address associated with the source computing system matches an IP address previously designated as associated with a trustworthy source, further comprising comparing an authentication certificate associated with the source computing system with one or more authentication certificates previously designated as associated with trustworthy sources.

9. The computer implemented method of claim 8, wherein if an authentication certificate associated with the source computing system matches one or more authentication certificates associated with source computing systems previously designated as trustworthy sources, allowing an upload of the requested data from the source computing system to the destination computing system.

10. The computer implemented method of claim 9, wherein if the authentication certificate associated with the source computing system does not match one or more authentication certificates associated with source computing systems previously designated as trustworthy sources, rejecting an upload of the requested data from the source computing system to the destination computing system.

11. The computer implemented method of claim 10, further comprising requiring additional authentication information from the source computing system prior to allowing an upload of the requested data from the source computing system to the destination computing system.

12. A system for uploading data from a source computing system to a secure destination computing system, the system comprising:
one or more processors;
memory storing one or more modules that are executable by the one or more processors, the one or more modules comprising:
a data uploader module operative to
receive a request to upload data from a source computing system to a destination computing system;
upload the requested data to a proxy service operative to authenticate the source computing system as a trustworthy source;
the proxy service being further operative to
determine whether the source computing system from which the data is uploaded is a trustworthy source by comparing authentication information provided with the uploaded requested data with authentication information associated with previously designated secure source computing systems; and
upload the requested data to the destination computing system if the source computing system is determined to be a trustworthy source.

13. The system of claim 12, the data uploader module being further operative to determine whether the data upload from the source computing system must be authenticated before it may be uploaded to the destination computing system.

14. The system of claim 13, the data uploader module being further operative to
read a configuration file for determining an export plug-in module required for uploading data from the source computing system to the destination computing system; and
upload the data to the proxy service via the export plug-in module where the export plug-in module configured for the data upload is associated with the proxy service because the data upload requires authentication before being uploaded to the destination computing system.

15. The system of claim 12, the proxy service being further operative to determine whether the source computing system from which the data is uploaded is a trustworthy source by comparing an Internet protocol (IP) address associated with the source computing system with one or more IP addresses previously designated as associated with trustworthy sources.

16. The system of claim 15, the proxy service being further operative to allow an upload of the requested data from the source computing system to the destination computing system if an IP address associated with the source computing system matches an IP address previously designated as associated with a trustworthy source.

17. The system of claim 15, the proxy service being further operative to compare an authentication certificate associated with the source computing system with one or more authentication certificates previously designated as associated with trustworthy sources as an additional authentication step if an IP address associated with the source computing system matches an IP address previously designated as associated with a trustworthy source.

18. The system of claim 17, the proxy service being further operative to allow an upload of the requested data from the source computing system to the destination computing system if an authentication certificate associated with the source computing system matches one or more authentication certificates associated with source computing systems previously designated as trustworthy sources.

19. The system of claim 18, the proxy service being further operative to reject an upload of the requested data from the source computing system to the destination computing system if the authentication certificate associated with the source computing system does not match one or more authentication certificates associated with source computing systems previously designated as trustworthy sources.

20. A computer readable medium having computer executable instructions which when executed by a computer perform a method for uploading data from a source computing system to a secure storage repository, comprising:
receiving a request to upload data from a source computing system to a destination storage repository;
determining whether the data upload from the source computing system must be authenticated before it may be uploaded to the destination storage repository by reading a configuration file and obtaining an export plug-in module for the requested data upload that passes uploaded data to a proxy service;
uploading the requested data to the proxy service for authenticating the source computing system as a trustworthy source;
at the proxy service, determining whether the source computing system from which the data is uploaded is a trustworthy source by comparing authentication information provided with the uploaded requested data with authentication information associated with previously designated secure source computing systems; and
if the source computing system is determined to be a trustworthy source, uploading the requested data to the destination storage repository.
